(19) United States
(12) Patent Application Publication
(10) Pub. No.: US 2003/0023793 A1
(43) Pub. Date: Jan. 30, 2003

(54) Method and apparatus for in-system programming through a common connection point of programmable logic devices on multiple circuit boards of a system

(76) Inventors: Paul J. Mantey, Ft. Collins, CO (US); Wendy Heisterkamp, Ft. Collins, CO (US); David Maciorowski, Parker, CO (US)

Correspondence Address: HEWLETT-PACKARD COMPANY, Intellectual Property Administration, P.O. Box 272400, Fort Collins, CO, 80527-2400, US

(21) Appl. No.: 09/918,023

(22) Filed: Jul. 30, 2001

(51) Int. Cl. G06F 13/00

(52) U.S. Cl. 710/100; 711/103

(57) ABSTRACT

A method and apparatus is described for the in-system programming of EEPROMs with configuration code for programmable logic devices such as FPGAs. The method and apparatus is suitable for use in larger systems where not all of the EEPROMs are located on the same circuit board. Multiple board-specific serial busses are provided, where each serial bus connects to EEPROMs of a particular circuit boards and to a common configuration point having selection apparatus and a header for coupling to configuration apparatus. The method includes the steps of setting the selection apparatus to designate a particular bus, erasing at least one EEPROM coupled to the serial bus, and writing programmable logic device configuration code through the serial bus to the EEPROM. Further claims include accessing the bus prior to writing any EEPROM to verify compatibility of a code file with the selected circuit board.

### RELATED APPLICATIONS

This application is related to copending and cofiled applications for U.S. Pat. Ser. No. ______, filed ______ and entitled SYSTEM AND METHOD FOR IN-SYSTEM PROGRAMMING THROUGH AN ON-SYSTEM JTAG BRIDGE OF PROGRAMMABLE LOGIC DEVICES ON MULTIPLE CIRCUIT BOARDS OF A SYSTEM (Attorney Docket No. 10016250-1); Ser. No. ______, filed ______ and entitled METHOD FOR ACCESSING SCAN CHAINS AND UPDATING EEPROM-RESIDENT FPGA CODE THROUGH A SYSTEM MANAGEMENT PROCESSOR AND JTAG BUS (Attorney Docket No. 10017840-1); and Ser. No. ______, filed ______ and entitled METHOD AND APPARATUS FOR SERIAL BUS TO JTAG BUS BRIDGE (Attorney Docket No. 10017841-1), all of the aforementioned applications incorporated herewith by reference thereto.

### FIELD OF THE INVENTION

The invention is related to the art of providing configuration code information to programmable logic devices, including Field Programmable Gate Array (FPGA) devices in complex electronic system. In particular, the invention relates to methods and apparatus for programming FPGA code into EEPROM associated with FPGAs, or into EEPROM of FPGAS, through a central point in a system and over JTAG serial busses.

### BACKGROUND OF THE INVENTION

Serial communications busses of the separate-clock-and-data type have become commonly used for communication between integrated circuit components of a system. Serial links of this type include the IIC (initially known as the Inter IC bus, now widely known as I2C) and SPI busses. Links of this type can be implemented without need of precision timing components at each integrated circuit on the bus and typically operate under control of at least one bus master. Serial EEPROM (Electrically Erasable Programmable Read-Only Memory) devices are widely available that interface with serial communications busses of the SPI and IIC types.

While the I2C and SPI busses are typically used for communications within systems during normal operation, the IEEE 1149.1 serial bus, known as the JTAG bus, was intended for testing of inactive systems by providing access from a tester to perform a boundary scan on each integrated circuit. The tester can thereby verify connectivity of the integrated circuits and verify that they are installed and interconnected correctly. The JTAG bus provides for interconnection of one or more integrated circuits in a chain, any of which may be addressed by the tester. Typically, multiple devices of a circuit board are interconnected into a JTAG bus.

The JTAG bus uses four wires. These include a serial data-in line, a serial data-out line, a clock line, and a test mode select line. Typically the data-out line of a first chip in a chain couples to the data-in line of a second chip of the chain, and the data-out line of the second chip couples to the data-in line of a third. The data-in and data-out lines of multiple chips are therefore coupled in a daisy-chain configuration.

The IEEE 1152 bus is a newer, enhanced, version of the 1149.1 JTAG bus. References herein to a JTAG bus are intended to include both the 1149.1 and 1152 variations.

Programmable Logic Devices, herein referenced as PLDs, are commonly used as components of computer systems. These devices include a Programmable Array Logic devices (PALs), Programmable Logic Arrays (PLAs), Complex Programmable Logic Devices (CPLDs), and Field Programmable Gate Arrays (FPGAs). PLDs are typically general-purpose devices that take on a system-specific function when a function-determining, or configuration, code is incorporated within them. PLDs may store the function-determining code in fusible links, antifuses, EPROM cells, EEPROM cells including FLASH cells, or static RAM cells.

Those PLD devices which utilize static RAM cells to hold their function-determining code may be designed to automatically retrieve that code from an EEPROM on the same or different integrated circuit at system power-up. Many common FPGA devices available from xilinx, Altera, Lucent, and Atmel are known as SRAM-based FPGAs because they store their codes in static RAM cells.

FPGAs of this type are known that can retrieve configuration code from an external EEPROM in either serial or parallel mode at system power-up. These devices are typically configured to automatically retrieve their configuration code on system power-up. FPGAs that retrieve configuration code in serial mode can be designed to use a custom serial bus designed for loading code into an FPGA, and can be designed to use a standard serial bus such as the IIC and SPI busses although many such devices use custom serial busses. The term serial bus as used herein therefore is inclusive of IIC, SPI, and custom serial busses.

FPGAs are also known that are capable of performing a checksum verification on their configuration code when they receive it from an EEPROM. These FPGAs generate an error signal when the checksum verification fails, indicating that their configuration code might not be correct.

It is known that some EEPROM devices, including but not limited to Xilinx XC18V00 series devices, can interconnect to the JTAG bus and may be erased and programmed with a configuration code over the JTAG bus. Further, it is known that these devices can be connected to an FPGA to provide configuration code to the FPGA. It is also known that some FPGA devices can also interconnect to a JTAG bus for test or configuration purposes.

It is known that a portable programming device may connect to a JTAG bus of a board through an in-system configuration header on the board. The JTAG bus couples to at least one JTAG-configurable EEPROM on the board, that are in turn coupled to configure FPGAs on the board. A configuration system is coupled to the JTAG bus through the header; and the system is placed in a configuration mode. Configuration code is then written from the configuration system, through the header, and over the JTAG bus, into the EEPROM. Once the code is in the EEPROM, system power may be cycled; at which time the configuration code is transferred into the associated FPGA. This process is outlined in XILINX datasheet DS026 and other documents available from XILINX.

The configuration system is typically a notebook computer having configuration code for the FPGAs of the board. The configuration system also has suitable software and hardware for driving the JTAG bus of the board, together with knowledge of the JTAG bus configuration of the board.

While loading FPGA configuration code into EEPROMs of a board works well for small systems, it can pose difficulties with large systems. Large systems may have multiple boards, not all of which are connected to the same JTAG bus. Separate chains are often used because:

1. a configuration system must have knowledge of all devices in the chain in order to properly address any device on the chain; if a single chain is used the configuration system must have detailed knowledge of every board in the system.

2. large systems may, and often do, have slots permitting later addition or upgrade of peripheral devices, memory subsystems, processors, and other subsystems; additional circuitry would be required to avoid breaking a single chain at any empty slot.

3. large systems are often customized before shipment with a specific set of peripheral devices, memory subsystems, processors, and other devices; a single chain could require customized JTAG interface software for each system configuration.

4. access is faster to devices in short chains than to devices in long chains. A single board may, but need not, therefore embody more than one chain within the board.

The prior configuration process also poses difficulties when separate JTAG busses are used to load FPGA configuration code into EEPROMs of each board of a large system. For example, the multiple circuit boards of large systems are often not readily accessible for coupling of a configuration system to a configuration header without removing them from the system. Certain boards may be accessible, but only if one or more additional boards are first removed from the system. Physical access to a system by a technician also may require travel expense. In either case, substantial labor and system downtime may be required to update the FPGA configuration codes of all boards of a large system.

It is known that computer systems may have more than one data communications bus for different purposes. For example, commonly available computers have a PCI bus for communications with peripheral interface cards, one or more processor busses interfacing to each processor, and busses of other types. Complex systems may also utilize serial busses for particular purposes. For example, a complex computer system may use an IIC or SPI bus as a system management bus.

A bus bridge is a device for interconnecting busses of different types. For example, a typical personal computer utilizes at least one bus bridge between parallel busses, coupling a processor bus to a PCI bus.

A system management bus may provide an interface to system functions including, but not limited to, power supply voltage monitors, temperature sensors, fan controls, and fan speed monitors to a dedicated system management processor. The system management processor may in turn be interfaced through appropriate hardware, which may include one or more bus bridges, to other processors of the system.

In such a system, the system management processor may monitor system functions and determine if any system functions exceed limits. When limits are exceeded, the system management processor can protect the system by altering fan speeds, by instructing the system to operate in particular modes, including shutdown, or by other means known in the art.

Complex computer systems may embody multiple FPGAs and other PLDs. FPGAs may be used for customized I/O functions interfacing CPUs of the system to other devices, for communications between CPUs, and to interface devices such as fans and temperature sensors to a system management bus.

### SUMMARY OF THE INVENTION

The present invention is a system having multiple, interconnected, circuit boards, several of which have at least one EEPROM to provide configuration code to an FPGA. The EEPROM devices of each such board are coupled into a JTAG bus, with a separate chain for each such board. The JTAG buss from each such board are connected to a central system-configuration point. The system-configuration point is located on a particular board that is readily accessible to a technician for connection of a configuration header.

The system-configuration point is equipped with a rotary switch for determining which of several board-specific JTAG busses are to receive configuration code information through the configuration header.

When it is necessary to update the FPGA code of boards of the system, a technician accesses the system and couples a configuration system to the configuration header. The technician then sets the rotary switch to a setting appropriate for the first board to receive configuration code. Once the switch is set, configuration code is transferred from the configuration system into the EEPROMs of the board. Once the first board has received configuration code, the switch may be reset to a setting appropriate for the next board to receive configuration code, and configuration code is transferred into that board.

### BRIEF DESCRIPTION OF THE DRAWINGS

FIG. 1 is a block diagram of a prior art computer system having multiple JTAG busses on multiple boards, each board having a separate configuration header;

FIG. 2 is a block diagram of a computer system having multiple JTAG busses from multiple boards brought to a common system-configuration point;

FIG. 3 is a block diagram of a common system-configuration point of the system of FIG. 2;

FIG. 4 is a flowchart of a method of configuring FPGAs of a system through a common system-configuration point.

### DETAILED DESCRIPTION OF THE EMBODIMENTS

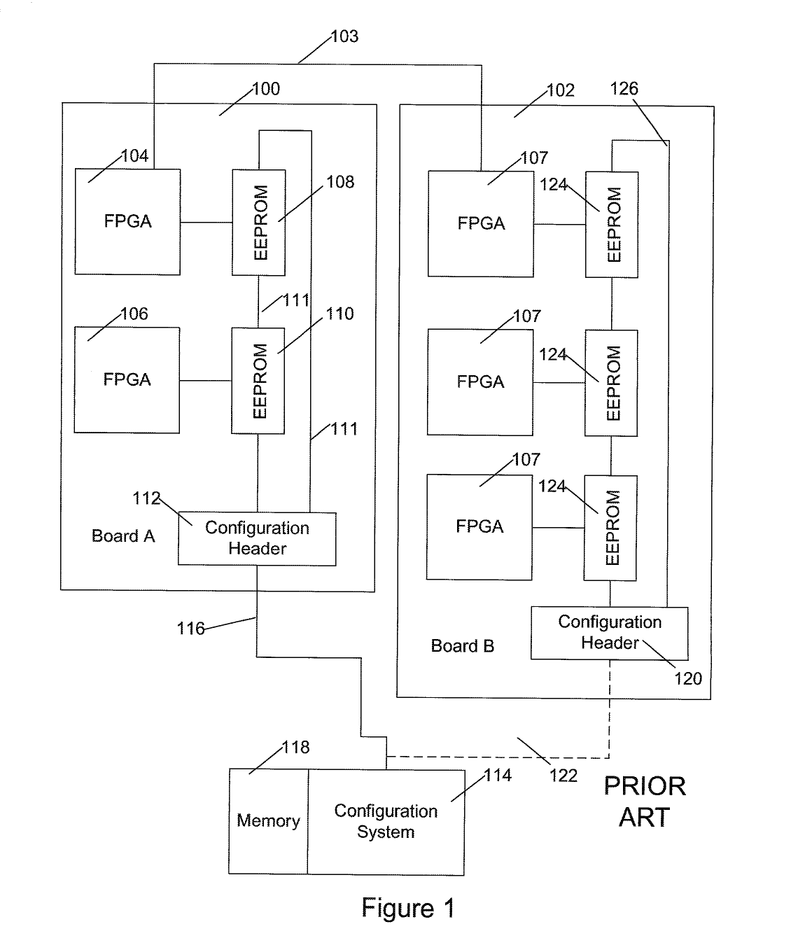

A computer system as known in the art incorporates multiple circuit boards, such as Board A 100 (FIG. 1) and Board B 102 embodying FPGAs 104, 106, 107 on the boards. There may be additional boards in the system, both with and without FPGAs, the various boards being coupled together 103 as components of the system. On Board A 100, FPGA 104 is coupled to a configuration EEPROM 108, such that FPGA 104 receives its configuration code from EEPROM 108 when Board A 100 is powered-up. Similarly, FPGA 106 is coupled to a second configuration EEPROM 110. Configuration EEPROMs 108 and 110 are chained together in a JTAG bus 111, that is brought out to a configuration header 112.

When it is desired to update configuration code of one or more of the FPGAs 104 or 106 on Board A 100, a configuration system 114 is coupled through a configuration cable 116 to configuration header 112. Configuration code may then be transferred from a memory system 118 of configuration system 114, through configuration cable 116 and configuration header 112, and over the JTAG bus 111, into an EEPROM such as EEPROM 108. Once this is accomplished, power may be cycled to cause FPGA 104 to load the updated configuration code from EEPROM 108.

When it is desired to update configuration code of FPGAs on a different board, such as Board B 102, the configuration cable 116 is disconnected from configuration header 112 and coupled to an appropriate configuration header 120 of Board B, along an alternate configuration cable routing 122. The process is then repeated to update appropriate EEPROMs of EEPROMs 124 over a Board B JTAG bus 126.

The prior-art in-system FPGA configuration code update apparatus illustrated in FIG. 1 requires physical access to each board of the system that is to be updated, so that the configuration cable 116 can be connected to appropriate configuration headers.

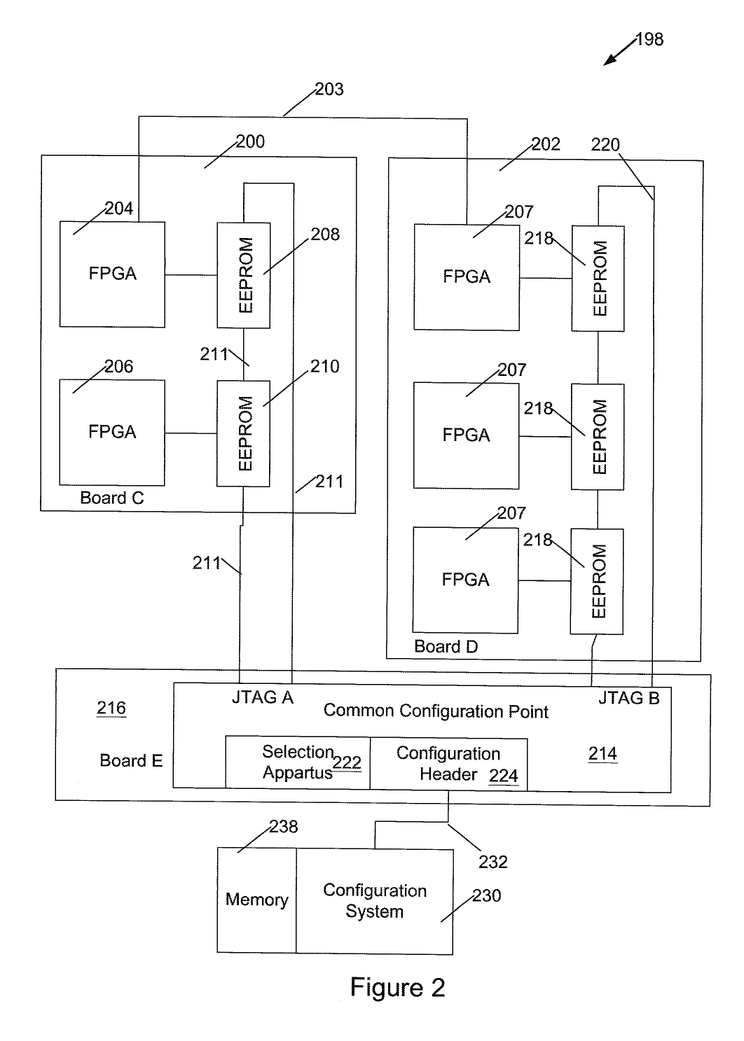

In a computer system 198 of the present invention, there are multiple circuit boards, such as Board C 200 (FIG. 2) and Board D 202 embodying FPGAs 204, 206, 207. There may be additional boards in the system, both with and without FPGAs, the various boards being coupled together 203 as components of the system. On Board C 200, FPGA 204 is coupled to a configuration EEPROM 208, such that FPGA 204 receives its configuration code from EEPROM 208 when Board C 200 is powered-up. Similarly, FPGA 206 is coupled to a second configuration EEPROM 210. Configuration EEPROMs 208 and 210 are chained together in a JTAG chain, or JTAG bus, 211.

JTAG bus 211 is brought to a common configuration point 214 which may be located on a third board, Board E 216, of the system.

Similarly, FPGAs 207 of Board D are coupled to receive configuration code from EEPROMs 218, which are coupled into a JTAG bus 220 that is also coupled to the common configuration point 214. Common configuration point 214 incorporates selection apparatus 222 and a configuration header 224.

When it is desired to update configuration code of one or more of the FPGAs 204 or 206 on Board C 200, a configuration system 230 is coupled through a configuration cable 232 to configuration header 224. The selection apparatus 222 is then set such that the Board C JTAG bus 211 is selected for programming. Configuration code may then be transferred from a memory subsystem 238 of configuration system 230 through configuration cable 232, configuration header 224, over the JTAG bus 211, and into an EEPROM such as EEPROM 208. Once this is accomplished, power may be cycled to cause FPGA 204 to load the updated configuration code from EEPROM 208.

If it is also desired to update configuration code of FPGAs on a different board, such as Board D 202, there is no need to move configuration cable 232—it is left coupled to configuration header 224. Selection apparatus 222 is altered to designate the Board D JTAG bus 220 for programming. Configuration code is then transferred to update appropriate EEPROMs, such as EEPROMs 218, over Board D JTAG bus 220 from memory subsystem 238 of the configuration system 230.

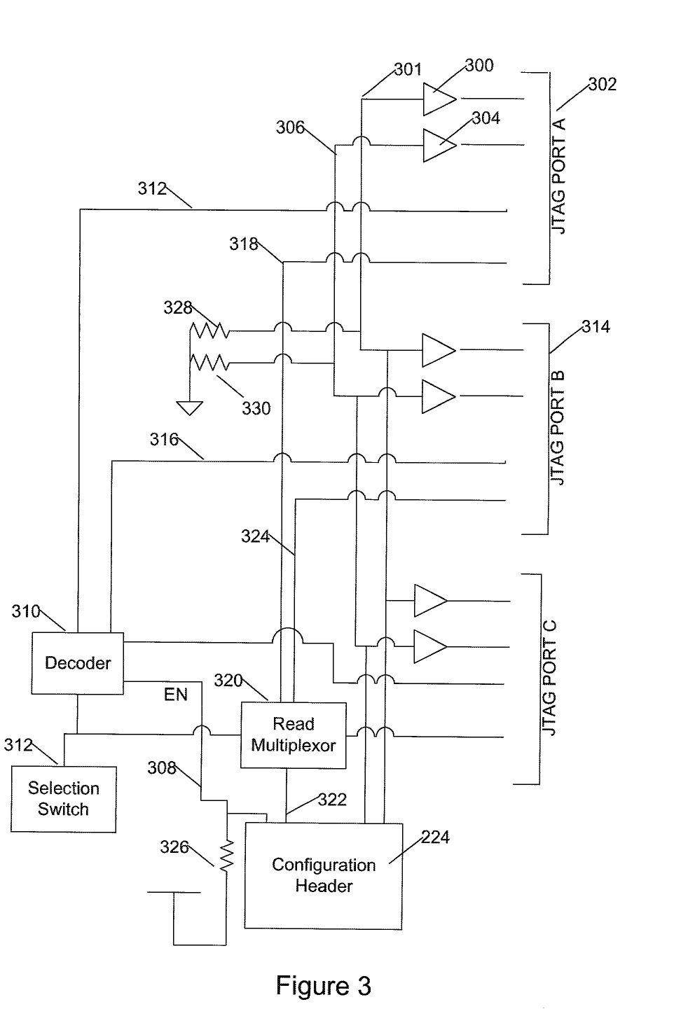

The common configuration point 214 of a particular embodiment has a clock line buffer 300 (FIG. 3) to buffer JTAG clocks 301 received through configuration header 224 and provide them to a first 302 of the multiple board-specific JTAG configuration busses. Similarly, a data line buffer 304 buffers JTAG serial data 306 and provides data to JTAG bus 302. Test Mode line 308 from configuration header 224 is routed to an enable input of a decoder device 310.

The decoder device 310 also receives a binary select code from binary coded selection switch 312, and passes test mode line information from header test mode line 308 to a selected board-specific test mode line. When the first 302 of the multiple board-specific JTAG configuration busses is selected, decoder device 310 passes test mode line information to the test mode line 312 of JTAG bus 302. Similarly, should the second 314 of the multiple board-specific JTAG configuration busses be selected, decoder device 310 passes test mode line information to the test mode line 316 associated with the second 314 JTAG configuration bus.

JTAG serial data out line 318 passes from first 302 of the multiple board-specific JTAG configuration busses to a read multiplexor 320. When the first 302 of the busses is selected, this read data is passed on to the JTAG data out line 322 of header 224. Similarly, should the second 314 JTAG bus be selected, its bus-specific JTAG serial data output line 324 is coupled through the read multiplexor 320 to JTAG data out line 322. Resistors 326, 328, and 330 are provided to ensure that the header JTAG clock, JTAG data input, and JTAG test mode select lines are at defined levels whenever no configuration system is connected to the header.

The invention has been described with reference to a read multiplexor for selecting a board JTAG port to be read to the common configuration point configuration header 224. It is anticipated that a decoder and tristate gates would be operable in place of the read multiplexor shown.

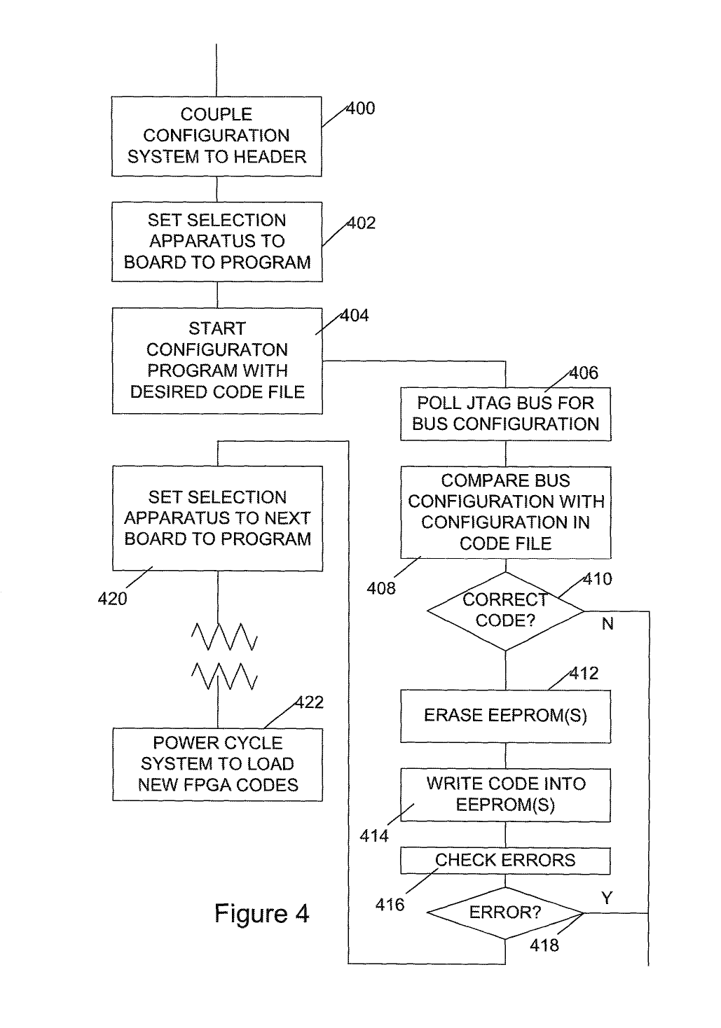

With reference to FIGS. 2, 3 and 4, when it is desired to program, or to change code for, an FPGA without removing the affected board from the system, a technician couples 400 (FIG. 4) a configuration system 230 to the configuration header 224. The technician then sets 402 selection switch 312 to designate a particular JTAG bus of the system having the EEPROM associated with the FPGA. The technician then starts 404 a configuration program on the configuration system, and designates an FPGA code file appropriate for the affected JTAG bus.

The configuration system addresses the selected JTAG bus and determines 406 the JTAG bus configuration, including the number and types of devices on the bus. This is accomplished in part through using the JTAG “GET_DEVICE_ID” command, that returns a code indicative of the type of each device connected to the JTAG bus. This is compared 408 against information in the FPGA code file to ensure that switch 312 is correctly set and that code is not programmed into a board not compatible with it. Should the code be incompatible with the selected board, an error is declared 410. These steps verify compatibility of the code file with the selected circuit board.

In an alternative embodiment, instead of, or in addition to, comparing JTAG bus configuration against information in the code file, board identification information is read from an EEPROM located on the board. This board identification information is used to verify compatibility of the code file with the board, and may also be used to select appropriate FPGA code from among several FPGA codes contained within the code file.

Next, the configuration system erases 412 one or more EEPROMs of the board that are attached to the JTAG bus. More than one EEPROM may be erased should the FPGA code file contain code for more than one FPGA of the board. Then, the configuration system writes 414 new code into the erased EEPROM(s). Finally, the configuration system checks 416 for errors in the EEPROM writing process and declares an error 418 if any error occurred and was reported by an EEPROM. If the code file was written correctly into the EEPROMS of the board, the technician is so notified. The technician may then reset 420 the selection switch to indicate the next JTAG bus to be programmed, if any, and restart the configuration program to program that JTAG bus in the same way as described for the first JTAG bus.

After all JTAG bus of the system have been programmed, the technician power-cycles 422 the system, such that each FPGA of the system reloads its code from the associated EEPROMs at power-up.

While the invention has been described with reference to selection apparatus comprising a binary coded switch and decoder as illustrated in FIG. 3, it is anticipated that it would be operable with alternative circuitry.

While FIG. 3 illustrates a common configuration point having three board-specific JTAG busses to avoid clutter, the invention is applicable to other numbers of board-specific JTAG busses. A particular embodiment of the invention embodies ten board-specific JTAG busses.

It is also anticipated that the invention would be operable with electronic selection apparatus. Such electronic selection apparatus could take the form of an IIC or JTAG addressable register, operating under control of the configuration system to automate selection of particular board-specific JTAG busses of the system.

While the invention has been described with reference to a separate configuration system coupled to a configuration header of a common configuration point, it is anticipated that the invention would be operable should the system incorporate JTAG interface hardware in place of, or in addition to, the configuration header illustrated. In this way, need of a separate configuration system could be eliminated.

The invention has been described with reference to board specific JTAG busses. It is anticipated that one or more boards of a system may have more than one such JTAG bus on the board.

While the invention has been particularly shown and described with reference to a preferred embodiment thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. A method of in-system programming of EEPROMs, the EEPROMs coupled to provide configuration code to programmable logic devices, each EEPROM being located on a particular circuit board of a plurality of circuit boards of a system and wherein not all EEPROMs are located on the same circuit board, comprising:
providing a plurality of board-specific serial busses, each board-specific serial bus coupling to EEPROMs of a particular circuit board;
coupling the plurality of board-specific serial busses to a common configuration point having selection apparatus;
coupling the common configuration point to configuration apparatus capable of interacting with at least one serial bus to program EEPROMs;
setting the selection apparatus to select a particular board-specific serial bus of the plurality of board-specific serial busses;
erasing at least one EEPROM coupled to the particular board-specific serial bus; and
writing programmable logic device configuration code through the selected board-specific serial bus to the at least one EEPROM.

2. The method of claim 1, wherein the plurality of board-specific serial busses are of the JTAG type.

3. The method of claim 2, wherein the programmable logic device configuration code comprises configuration code for at least one FPGA.

4. The method of claim 3, further comprising the step of accessing the particular board-specific serial bus to verify compatibility of the code file with the selected circuit board.

5. The method of claim 4, wherein at least one EEPROM device is collocated on the same die as at least one FPGA.

6. The method of claim 4, further comprising the step of loading at least one of the programmable logic devices with configuration code from at least one of the EEPROMs.

7. Common connection point apparatus for in-system programming of EEPROMs, at least some of the EEPROMs coupled to provided code to programmable logic devices, each EEPROM located on a particular circuit board of a plurality of circuit boards of a system and where not all EEPROMs are located on the same circuit board, comprising:
interface apparatus for a plurality of serial busses, each serial bus intended for coupling to EEPROMs of a particular circuit board;
interface apparatus for connecting a configuration system;
selection apparatus for selecting a particular bus of the plurality of serial busses; and
coupling apparatus for coupling signals from the configuration system to the particular bus of the plurality of serial busses.

8. The connection point apparatus of claim 7, wherein the serial busses are JTAG busses.

9. The connection point apparatus of claim 8, wherein the selection apparatus comprises a switch settable by a technician.

10. The connection point apparatus of claim 8, wherein the selection apparatus comprises a register addressable by the configuration apparatus.

11. A system comprising:
a plurality of interconnected circuit boards, at least two of the plurality of interconnected circuit boards embodying at least one FPGA coupled to a configuration EEPROM of the type capable of being programmed over a serial bus;
wherein at least one EEPROM of a circuit board of the plurality of circuit boards is coupled to a first serial bus, and at least one EEPROM of a circuit board of the plurality of circuit boards is coupled to a second serial bus;
common configuration point apparatus coupled to the first serial bus and to the second serial bus, the common configuration point apparatus further comprising:
selection apparatus for selecting a particular bus of the first and second serial busses; and
coupling apparatus for coupling configuration signals to the particular bus of the plurality of serial busses.

12. The system of claim 10, wherein the first serial bus and the second serial bus are of the JTAG type.
